(19) United States
(12) Patent Application Publication
(10) Pub. No.: US 2011/0267170 A1
(43) Pub. Date: Nov. 3, 2011

(54) METHOD FOR PROCESSING SIGNALS RECEIVED BY A WIRELESS CONTROLLED CIRCUIT OF A STEAM DEVICE

(75) Inventor: Wei-cong Huang, Foshan City (CN)

(73) Assignee: Foshan Shunde Sincere-Home Home Appliance Manufacturing Co., Ltd., Foshan (CN)

(21) Appl. No.: 12/975,985

(22) Filed: Dec. 22, 2010

(30) Foreign Application Priority Data
Apr. 30, 2010 (CN) 201010170334.5

(51) Int. Cl. G05B 19/00

(52) U.S. Cl. 340/5.2

(57) ABSTRACT

A method for processing signals received by a wireless controlled circuit of a steam device, includes the steps of: judging a received signal is a registration signal or a control signal; if the received signal is a registration signal, storing an ID code contained in the registration signal; and if the received signal is a control signal, judging whether the control signal contains an ID code same as a stored ID code or not, then responding a control instruction contained in the control signal if yes, and not responding the control instruction contained in the control signal if no. The present invention has the following advantages: when a plurality of the steam devices are placed together, each wireless controlled circuit of the steam devices will only respond the special remote controller which is registered correspondingly and not respond a non-corresponding remote controller.

### CROSS-REFERENCE TO RELATED APPLICATIONS

The present invention claims priority from Chinese Application No. 201010170334.5, filed Apr. 30, 2010, the disclosure of which is hereby incorporated by reference herein.

### FIELD OF THE INVENTION

The present invention relates to a functional module framework for realizing a method for processing signal received by a wireless controlled circuit of a steam device.

### BACKGROUND OF THE INVENTION

Steam devices include steam mops, steam cleaners, dust collectors, and so on. Some steam devices are controlled by remote controllers which control the wireless controlled circuits of the steam devices. If a plurality of steam devices with the same signal system are placed together, and when a user uses a remote controller to control a wireless controlled circuit of one of the steam devices, other steam devices which the user does not want to control might make a response by mistake.

### SUMMARY OF THE INVENTION

The problem to be solved by the present invention is that when a remote controller of a steam device controls a wireless controlled circuit of the steam device, the wireless controlled circuits of others nearby steam devices using the same signal system might respond a control instruction of the remote controller by mistake.

According to the embodiment of the present invention, a method for processing signals received by a wireless controlled circuit of a steam device, includes the steps of: judging a received signal is a registration signal or a control signal; if the received signal is a registration signal, storing an ID code contained in the registration signal; and if the received signal is a control signal, judging whether the control signal contains an ID code same as a stored ID code or not, then responding a control instruction contained in the control signal if yes, and not responding the control instruction contained in the control signal if no.

According to one aspect of the present invention, when storing the ID code contained in the registration signal, a previous ID code different from the ID code in the registration signal will be covered.

According to the embodiment of the present invention, a computer-readable storage medium storing instructions for controlling a computer system to process the signal received by a wireless controlled circuit of a steam device is provided. The instructions of the computer-readable storage medium control the computer system to execute the following steps: judging the received signal is a registration signal or a control signal; if the received signal is a registration signal, storing an ID code contained in the registration signal; and if the received signal is a control signal, judging whether the control signal contains an ID code same as a stored ID code, then responding a control instruction contained in the control signal if yes, and not responding the control instruction contained in the control signal if no.

According to the embodiment of the present invention, a steam device includes a wireless controlled circuit, and an execution unit for processing the instructions stored in the computer-readable storage medium.

According to one aspect of the present invention, the execution unit is a MCU, a CPU or a CPLD.

The present invention has the following advantages: the wireless controlled circuit of a steam device will respond a control instruction of a remote controller only after registering the remote controller, thus when a remote controller of a steam device controls a wireless controlled circuit of a steam device, the wireless controlled circuits of others nearby steam devices using the same signal system will not respond the control instruction of the remote controller by mistake.

### BRIEF DESCRIPTION OF THE DRAWING

FIG. 1 is a schematic diagram of signal reception and information storage of a remote controller and a wireless controlled circuit of a steam device.

### DETAILED DESCRIPTION OF THE INVENTION

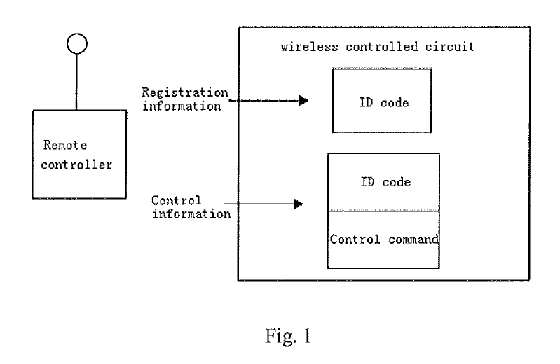

In the preferred embodiment of the present invention, wireless controlled circuits and remote controllers of a plurality of steam devices are provided, wherein each remote controller is marked by a special ID code. Referring to FIG. 1, each remote controller sends a registration signal containing its ID code to a corresponding wireless controlled circuit, and the controlled circuit is informed to register the ID code. Each remote controller can send a control signal containing a control instruction and the ID code of the remote controller to the wireless controlled circuit.

A method for processing signals received by the wireless controlled circuit of a steam device, includes the following steps of: judging a received signal is a registration signal or a control signal; if the received signal is a registration signal, storing the ID code in the registration signal; if the received signal is a control signal, judging whether the control signal contains an ID code same as a stored ID code or not; not responding a control instruction in the control signal if no, and responding the control instruction in the control signal if yes.

The step of storing the ID code contained in the registration signal includes the following steps of: if no ID code is stored, the ID code in the registration signal being stored; if an ID code same as the ID code in the registration signal has been stored, doing nothing; and if an ID code different from the ID code in the registration signal has been stored, covering the ID code stored before with the ID code in the registration signal.

In the method for processing signals received by the wireless controlled circuit of a steam device, all or part of the steps can be implemented by computer program instructions controlling a computer system through establishing a functional module framework. The computer program instructions are stored in a computer-readable storage medium.

The present invention has the following advantages: the wireless controlled circuit of a steam device will respond a control instruction of a remote controller only after registering the remote controller. As long as one remote controller is registered by a wireless controlled circuit once only, and the wireless controlled circuits of the steam devices are kept far away from each other and respectively register different remote controllers during registration, one-to-one relationships between the remote controllers and the wireless controlled circuits are established, so that even a plurality of the steam devices are placed together, each wireless controlled circuit of the steam devices will only respond the special remote controller which is registered correspondingly and not respond a non-corresponding remote controller.

In terms of number in the description, the “a plurality of” refers to more than or equal to two.

What is claimed is:

1. A method for processing signals received by a wireless controlled circuit of a steam device, comprising:
judging a received signal is a registration signal or a control signal;
if the received signal is a registration signal, storing an ID code contained in the registration signal; and
if the received signal is a control signal, judging whether the control signal contains an ID code same as a stored ID code or not, then responding a control instruction contained in the control signal if yes, and not responding the control instruction contained in the control signal if no.

2. The method of claim 1, wherein when storing the ID code contained in the registration signal, a previous ID code different from the ID code in the registration signal will be covered.

3. The method of claim 1, wherein the step of storing the ID code contained in the registration signal includes the following steps of:
if no ID code is stored, the ID code in the registration signal being stored;
if an ID code same as the ID code in the registration signal has been stored, doing nothing;
and if an ID code different from the ID code in the registration signal has been stored, covering the ID code stored before with the ID code in the registration signal.

4. A computer-readable storage medium storing instructions for controlling a computer system to process the signal received by a wireless controlled circuit of a steam device, the instructions controlling the computer system to execute the following steps:
judging the received signal is a registration signal or a control signal;
if the received signal is a registration signal, storing an ID code contained in the registration signal; and
if the received signal is a control signal, judging whether the control signal contains an ID code same as a stored ID code, then responding a control instruction contained in the control signal if yes, and not responding the control instruction contained in the control signal if no.

5. The computer-readable storage medium of claim 4, wherein when storing the ID code contained in the registration signal, a previous ID code will be covered.

6. A steam device, comprising:
a wireless controlled circuit; and
an execution unit for processing the instructions stored in the computer-readable storage medium of claim 4.

7. The steam device of claim 6, wherein the execution unit is a MCU, a CPU or a CPLD.

8. The steam device of claim 6, further comprising a remote controller marked by a special ID code, the remote controller being capable of sending a registration signal containing the ID code of the remote controller and a control signal containing a control instruction and the ID code of the remote controller to the wireless controlled circuit, the wireless controlled circuit being capable of receiving and processing the registration signal and the control signal send by the remote controller.
